(19) United States
(12) Patent Application Publication
(10) Pub. No.: US 2026/0197214 A1
(43) Pub. Date: Jul. 9, 2026

(54) OVER-PROVISIONED CYCLIC SHIFT CONFIGURATION FOR PRACH RESTRICTED SETS

(71) Applicant: QUALCOMM Incorporated, San Diego, CA (US)

(72) Inventors: Raviteja PATCHAVA, San Diego, CA (US); Jing SUN, San Diego, CA (US); Junyi LI, Greentown, PA (US); Jing JIANG, San Diego, CA (US)

(21) Appl. No.: 19/012,622

(22) Filed: Jan. 7, 2025

(51) Int. Cl. H04L 27/26; H04W 56/00; H04W 74/0833

(52) U.S. Cl. CPC H04L 27/2607; H04W 56/009; H04W 74/0833

(57) ABSTRACT

Aspects relate to providing over-provisioned cyclic shift configurations for physical random access channel (PRACH) restricted sets. The over-provisioned cyclic shift configuration for a preamble root sequence can include an allowed cyclic shift range including an allowed set of cyclic shifts associated with a cyclic shift step size less than a maximum round trip time (RTT) of a cell and respective restricted cyclic shift ranges adjacent to the allowed cyclic shift range on either side thereof.

### TECHNICAL FIELD

The technology discussed below relates generally to wireless communication networks, and more particularly, to synchronization signal designs in wireless communication networks.

### INTRODUCTION

Wireless communication systems, such as those specified under fifth generation (5G) systems, referred to as New Radio (NR) systems, sixth generation (6G) systems, and other future generation systems, may be widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power). In a communication network, in order for a user equipment (UE) to gain access to a cell either initially or after link failure, the UE may perform a random access procedure over a physical random access channel (PRACH). to acquire uplink synchronization and obtain specified network identification for obtaining radio access communication with the network.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus at a network entity is provided. The apparatus includes one or more memories and one or more processors coupled to the one or more memories. The one or more processors are configured to provide a cyclic shift configuration for a preamble root sequence to at least one user equipment (UE). The cyclic shift configuration includes an allowed cyclic shift range including an allowed set of cyclic shifts associated with a cyclic shift step size less than a maximum round trip time (RTT) of a cell associated with the network entity. The cyclic shift configuration further includes corresponding restricted cyclic shift ranges adjacent to the allowed cyclic shift range on either side thereof. The one or more processors are further configured to obtain a random access preamble message based on the cyclic shift configuration.

Another example provides a method operable at a network entity. The method includes providing a cyclic shift configuration for a preamble root sequence to at least one user equipment (UE). The cyclic shift configuration includes an allowed cyclic shift range including an allowed set of cyclic shifts associated with a cyclic shift step size less than a maximum round trip time (RTT) of a cell associated with the network entity. The cyclic shift configuration further includes corresponding restricted cyclic shift ranges adjacent to the allowed cyclic shift range on either side thereof. The method further includes obtaining a random access preamble message based on the cyclic shift configuration.

Another example provides an apparatus at a user equipment (UE) including one or more memories and one or more processors coupled to the one or more memories. The one or more processors are configured to receive a cyclic shift configuration for a preamble root sequence from a network entity. The cyclic shift configuration includes an allowed cyclic shift range including an allowed set of cyclic shifts associated with a cyclic shift step size less than a maximum round trip time (RTT) of a cell associated with the network entity. The cyclic shift configuration further includes corresponding restricted cyclic shift ranges adjacent to the allowed cyclic shift range on either side thereof. The one or more processors are further configured to transmit a random access preamble message based on the cyclic shift configuration.

Another example provides a method operable at a user equipment (UE). The method includes receiving a cyclic shift configuration for a preamble root sequence from a network entity. The cyclic shift configuration includes an allowed cyclic shift range including an allowed set of cyclic shifts associated with a cyclic shift step size less than a maximum round trip time (RTT) of a cell associated with the network entity. The cyclic shift configuration further includes corresponding restricted cyclic shift ranges adjacent to the allowed cyclic shift range on either side thereof. The method further includes transmitting a random access preamble message based on the cyclic shift configuration.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIG. 4 is a diagram illustrating an example of a random access procedure according to some aspects.

FIG. 5 is a diagram illustrating an example of a PRACH restricted cyclic shift configuration to manage higher Doppler cases according to some aspects.

FIG. 6 is a diagram illustrating an example of an over-provisioned cyclic shift configuration for PRACH restricted sets according to some aspects.

FIG. 7 is a diagram illustrating another example of an over-provisioned cyclic shift configuration for PRACH restricted sets according to some aspects.

FIG. 8 is a diagram illustrating an example of a random access procedure using an over-provisioned cyclic shift configuration according to some aspects.

FIG. 9 is a block diagram illustrating an example of a hardware implementation for UE employing a processing system according to some aspects.

FIG. 10 is a flow chart of an exemplary process for initiating a random access procedure using an over-provisioned cyclic shift configuration according to some aspects.

FIG. 11 is a block diagram illustrating an example of a hardware implementation for a network entity employing a processing system according to some aspects.

FIG. 12 is a flow chart of an exemplary process for configuring an over-provisioned cyclic shift configuration for a random access procedure according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

To gain initial access to a cell, a UE may perform a random access procedure over a physical random access channel (PRACH). The random access procedure involves a UE randomly selecting a preamble (e.g., a preamble sequence generated from a root and having a sequence length) from an available set of preambles within a cell served by a network entity, and transmitting the selected preamble to the network entity in a RACH preamble message, referred to, for example, as msg1. In some examples, the UE may further select a cyclic shift (e.g., a rotation in the time domain of the preamble sequence) from available cyclic shifts for the selected preamble and transmit the random access (RACH) preamble message with the selected cyclic shift. Upon receiving and decoding msg1, the network entity may transmit a random access response (RAR) message (msg2) to the UE containing an uplink grant for a radio resource control (RRC) connection request. The UE may then proceed with sending the connection request to the network entity in an uplink message (msg3) to which the network entity may respond in msg4.

In some examples, multiple UEs may select the same preamble for msg1, resulting in a collision in msg3 between the multiple UEs (e.g., each UE uses the same uplink resource to transmit respective connection requests). To prevent a msg3 collision, the network entity may detect a preamble (msg1) collision using, for example, multipath in the time domain. For example, using multipath, the network entity can assume that the same preamble sequence with the same cyclic shift arriving along different paths originated from different UEs. If a msg1 collision is detected, the network entity can transmit a new message (msgX) allocating resources for a new msg1 transmission (msgY transmission). The UEs that are allocated msgX then randomly select a new preamble and cyclic shift and transmit msgY to the network entity for collision resolution. However, this can result in false alarms of true multipath signals from a single UE PRACH transmission.

Although the network entity can be configured to balance collision false alarms with collision detection, collision false alarms may still occur and/or msg3 collisions may be missed. In addition, collision detection of msg1 transmissions using multipaths may work well in the case of large cells or cells with uniform distributions of round trip time (RTT) of transmissions between the network entity and UEs, where the received paths from multiple UEs that transmit the same cyclic shift arrive at different cyclic shifts due to channel randomness. However, in the case of a small cell (or a large cell with a hot spot with many UEs present in a small area), where there is not a significant separation between UE RTTs, there is a high probability that the network entity may detect only a single path if the UEs select the same preamble.

Therefore, to improve multipath detection, an over-provisioned cyclic shift configuration may be configured for a cell and provided to UEs to select a cyclic shift for a preamble message. A respective over-provisioned cyclic shift configuration may be configured for each root (e.g., within each root sequence). Each over-provisioned cyclic shift configuration includes a higher number of cyclic shifts within the root for the UE to select from. In some examples, the cyclic shifts in the over-provisioned cyclic shift configuration may be separated by a cyclic shift step size that is smaller than the maximum RTT in the cell. Since the number of cyclic shifts allowed within a root is higher, the probability of msg1 collision at the network entity is reduced.

However, high Dopplers in the range of subcarrier spacing may cause an additional cyclic shift in received PRACH preamble sequences, dependent on the root. To accommodate higher Dopplers, PRACH restricted sets may be designed to restrict sets of cyclic shifts from being selected by the UE. For example, a PRACH restricted set configuration may specify an allowed cyclic shift range including a set of allowed cyclic shifts and respective restricted cyclic shift ranges including respective sets of prohibited cyclic shifts on either side of the allowed cyclic shift range. The restricted cyclic shift ranges allow for a positive or negative Doppler shift of the allowed cyclic shifts in the allowed cyclic shift range.

Various aspects are related to providing over-provisioned cyclic shift configurations for PRACH restricted sets. The over-provisioned cyclic shift configuration for a preamble root sequence can include an allowed cyclic shift range including an allowed set of cyclic shifts associated with a cyclic shift step size less than a maximum round trip time (RTT) of a cell and respective restricted cyclic shift ranges adjacent to the allowed cyclic shift range on either side thereof. In some examples, the allowed set of cyclic shifts includes a first set of cyclic shifts having a first cyclic shift step size equal to or greater than the maximum RTT and a second set of cyclic shifts within respective cyclic shift durations of the first set of cyclic shifts excluding a last cyclic shift of the first set of cyclic shifts. For example, the second set of cyclic shifts can have a second cyclic shift step size offset from the first cyclic shift step size, in which the offset is less than the maximum RTT. In some examples, the second cyclic shift step size within each of the respective cyclic shift durations excluding the last cyclic shift can be less than the maximum RTT.

In some examples, the allowed set of cyclic shifts can include a respective range of cyclic shifts within the respective cyclic shift durations of the first set of cyclic shifts excluding the last cyclic shift of the first set of cyclic shifts. For example, the respective range of cyclic shifts can include all cyclic shifts within the respective cyclic shift durations of the first set of cyclic shifts excluding the last cyclic shift of the first set of cyclic shifts. In other examples, the allowed set of cyclic shifts can include individual cyclic shifts, each occurring at a select fraction of the maximum RTT within the respective cyclic shift durations of the first set of cyclic shifts excluding the last cyclic shift of the first set of cyclic shifts.

In some examples, the over-provisioned cyclic shift configuration can include at least two cyclic shift groups, each including a respective allowed cyclic shift range and respective corresponding restricted cyclic shift ranges for the corresponding cyclic shift group. In some examples, a respective over-provisioned cyclic shift configuration may be configured for each preamble root sequence (each root).

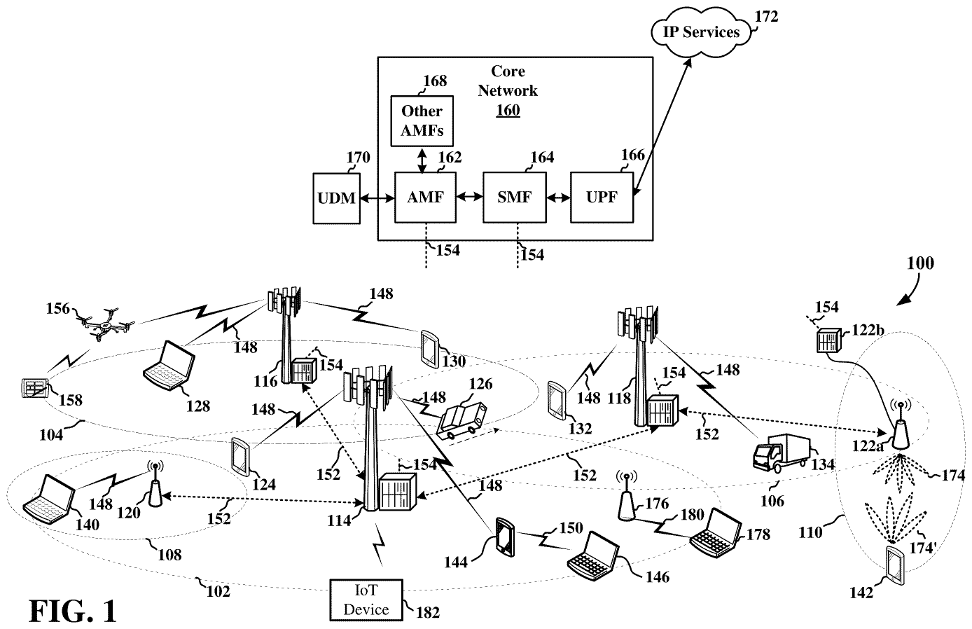

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of ims. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

In some examples, a UE may correspond to an IoT device 182. The IoT device 182 may include, for example, a passive IoT device, such as RFID-type sensor/actuator (SA), a semi-passive IoT device, or an active IoT device. Active IoT devices and semi-active IoT device may include a battery or power source that may be charged, for example, using wireless power transfer (WPT) or, more generally, ambient energy harvesting, whereas passive IoT devices lack an internal power source, and therefore, use ambient energy harvesting to power the device. Semi-passive IoT devices may include a capacitor or other storage device that provides a warm start-up to the energy harvesting in the device. The IoT device 182 may communicate with a network entity (e.g., network entity 114 or RFID reader). In some examples, the network entity 114 may communicate with the IoT device via cellular (Uu) links. For example, the network entity 114 may provide an energy transmission on the downlink to power the IoT device. The energy transmission may further be modulated and backscattered by the IoT device 182 as an information-bearing signal on the uplink. In addition, the network entity 114 may transmit control information and/or data to the IoT device 182 on the downlink, which may be detected by the IoT device using, for example, envelope detection. In this manner, the network entity 114 may read information from the IoT device 182 and write information to the IoT device 182.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

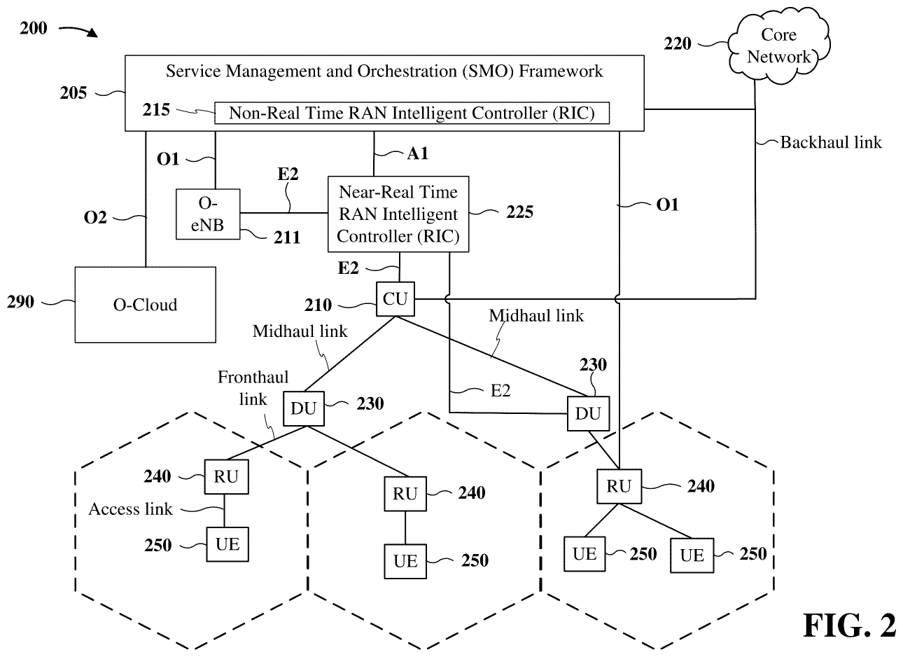

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

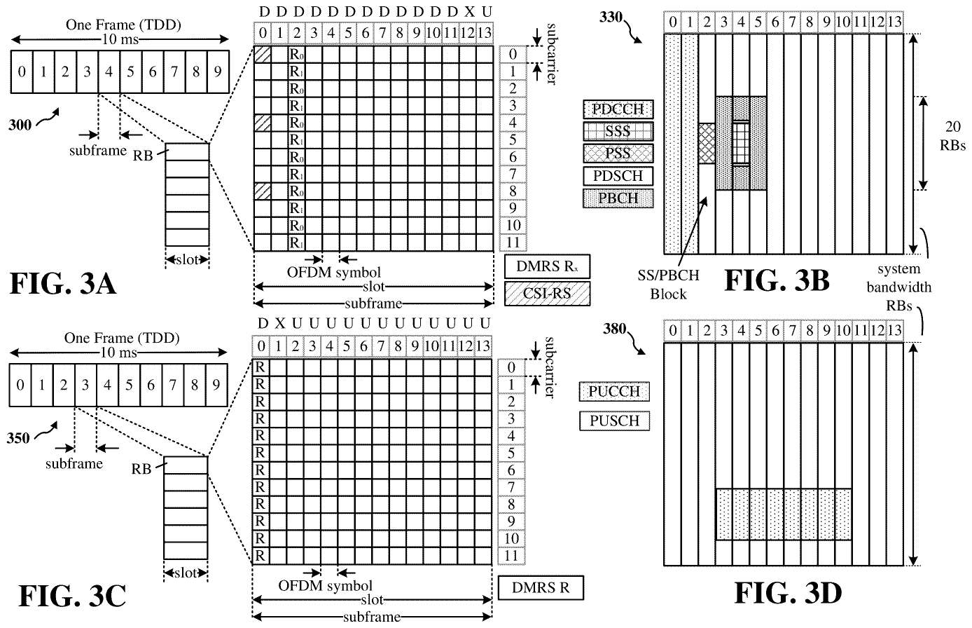

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

In order to gain access to a cell, a UE may perform a random access procedure over a physical random access channel (PRACH). The UE may identify a random access search space including PRACH resources for initiating a RACH procedure from the SIB1. For example, a random access process may be commenced after a UE acquires a cell and determines occurrence of a RACH occasion (e.g., PRACH resources) after reading SSB and a SIB1. The SSB provides the initial system information (SI), and the SIB1 (and other SIB blocks) provide the remaining minimum SI (RMSI). For example, the PBCH MIB of the SSB may carry a first part of the SI that a user equipment (UE) needs in order to access a network. The SIBs (e.g., SIB1 and SIB2) can carry the RMSI that a UE needs to gain access to the network.

RACH procedures may be performed in various scenarios, such as loss of uplink synchronization, lack of available PUCCH resources, scheduling request failure, and other use cases. In addition, a RACH procedure may be contention-based or contention-free and may include a 2-step RACH process (contention-based or contention-free), a 3-step RACH process (contention-free), or a 4-step RACH process (contention-based).

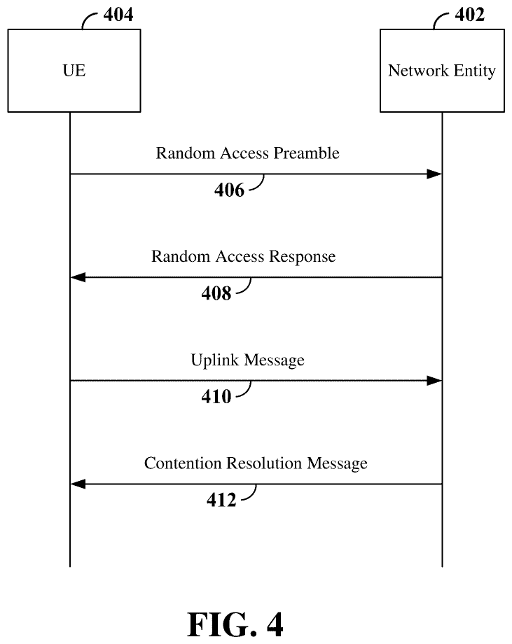

FIG. 4 is a diagram illustrating an example of a random access procedure according to some aspects. The random access procedure shown in FIG. 4 is a 4-step contention-based random access (CBRA) procedure 400 between a network entity 402 and a UE 404. The network entity 402 may correspond, for example, to any of the network entities shown in FIGS. 1 and/or 2. In addition, the UE 404 may correspond, for example, to any of the UEs shown in FIGS. 1 and/or 2.

The random access procedure 400 shown in FIG. 4 is initiated by the UE 404 randomly selecting a preamble from an available set of preambles within the cell served by the network entity 402, and transmitting the selected preamble to the network entity 402 in a RACH preamble message 406 (msg1). The msg1 406 may be transmitted by the UE 404 over a selected PRACH resource with power ramping. The selected PRACH resource may include supplementary uplink resources or normal uplink resources. Here, supplementary uplink resources include lower frequency resources than normal uplink resources. Thus, supplementary uplink resources and uplink resources each correspond to a different respective uplink frequency band. The msg1 406 may further be communicated on a beam selected by the UE 404 based on beam measurements (e.g., RSRP/RSRQ/SINR) performed by the UE 404. The beam may correspond, for example, to an SSB beam.

In an example, the UE 404 may select from 64 possible preamble sequences for inclusion in the RACH preamble message 406. In some examples, the UE 404 may further select a cyclic shift from a set of cyclic shifts associated with the selected preamble sequence. In some examples, the preamble sequence may be a Zadoff-Chu (ZC) sequence characterized by a root (root index, u=1, 2, . . . , N_{zc}−1) and a sequence length (N_{zc}). For example, the u^{th} ZC sequence sᵤ[n] can be defined as:

$${s}_{u} [ n ] = exp [ - j π u \frac{n ( n + 1 )}{{N}_{zc}} ] \qquad ( Equation 1 )$$

where n=0, 1, 2, . . . , N_{zc}−1. It should be noted that each ZC sequence has a length N_{zc} and the number of ZC sequences is N_{zc}−1. In some examples, as indicated above, there may be 64 possible ZC sequences (e.g., 64 roots) provided for selection by a UE for the RACH preamble message. A cyclic shift, also known as a circular shift, is a rotation of the ZC sequence (e.g., a time domain shift). For example, given a ZC sequence x[n] of length N, the n^{th} cyclic shift of x[n] can be:

$${x}^{( m )} [ n ] = x [ ( n + m ) mod N ] . \qquad ( Equation 2 )$$

Thus, while defined for all integers m, there are N unique cyclic shifts available for a ZC sequence. The available cyclic shifts for a selected preamble sequence may be limited, for example, by the maximum round trip time (RTT) between the UE 404 and the network entity 402 in the cell. Thus, in some examples, a set of nominal cyclic shifts available for a UE to select from may be configured based on a cyclic shift step size (e.g., a separation between the available cyclic shifts) that is greater than or equal to the maximum RTT.

As long as the cyclic shift step size is greater than or equal to the maximum RTT of the serving cell (and, in some cases, a maximum delay spread of the random access channel), the cross-correlation between different preambles that are based on cyclic shifts of a same preamble sequence may be zero at the network entity 402. Thus, the network entity 402 may identify an originating UE 404 (e.g., a source UE 404 from which the preamble was transmitted) for a received preamble based on the corresponding preamble sequence and cyclic shift. Specifically, the network entity 402 may process the preamble to detect or otherwise determine the preamble sequence and cyclic shift with which the preamble was generated. The cyclic shift detected at the network entity 402 may be based on the maximum RTT of the serving cell. That is, the network entity 402 may detect which cyclic shift was used to generate the preamble based on the detected cyclic shift and a propagation delay associated with the preamble.

If the preamble is successfully detected by the network entity 402, the network entity 402 transmits a random access response (RAR) message 408 (msg2) including a PDCCH and PDSCH to the UE 404. If no msg2 (RAR) 408 is received within a RAR window, the UE 404 may retransmit msg1 406 with power boost. The msg2 408 (PDCCH+PDSCH) includes an identifier of the preamble sent by the UE 404, a Timing Advance (TA) (e.g., based on the detected propagation delay), a temporary cell radio network temporary identifier (TC-RNTI) or random access (RA) RNTI for the UE 404 and a grant of assigned uplink (UL) resources. The PDCCH in msg2 408 may be scrambled with the RA-RNTI, which is a function of a RACH occasion (RO) (e.g., time-frequency resources allocated for RACH msg1) that the UE 404 used to send msg1 406. A medium access control—control element (MAC-CE) within the PDSCH provides an acknowledgement of the reception of msg1 and the UL grant. To receive msg2 408, the UE 404 may monitor DCI 1_0 for the PDCCH scrambled with the RA-RNTI corresponding to the RO used by the UE 404 to transmit msg1 406, and if detected, proceeds with PDSCH decoding. Upon receipt of the RAR message 408, the UE 404 compares the preamble ID to the preamble sent by the scheduled entity in the RACH preamble message 406. If the preamble ID matches the preamble sent in the RACH preamble message 406, the UE 404 applies the timing advance and starts a contention resolution procedure.

Since the preamble is selected randomly by the scheduled entity, if another UE selects the same preamble in the same RO, a collision may result between the two scheduled entities. Any collisions may then be resolved using the contention resolution procedure. During contention resolution, the UE 404 transmits an uplink message (msg3) 410 on the common control channel (CCCH) using the TA and assigned uplink resources in the PDSCH of msg2 408. In an example, the uplink message 410 is a Layer 2/Layer 3 (L2/L3) message, such as a Radio Resource Control (RRC) Connection Request message. The uplink message 410 includes an identifier of the UE 404 (UE-ID) for use by the network entity 402 in resolving any collisions. Although other UEs may transmit colliding uplink messages utilizing the TA and assigned uplink resources, these colliding uplink messages will likely not be successfully decoded at the network entity 402 since the colliding uplink messages were transmitted with TAs that were not intended for those UEs.

Upon successfully decoding the uplink message, the network entity 402 transmits a contention resolution message 412 to the UE 404 (msg4). The contention resolution message 412 may be, for example, an RRC-Connection Setup message. In addition, the contention resolution message 412 includes the identifier of the UE 404 that was received in the uplink message 410. The UE 404, upon receiving its own identity back in the contention resolution message 412, concludes that the random access procedure was successful and completes the RRC connection setup process. Any other UE receiving the RRC-Connection Setup message with the identity of the UE 404 will conclude that the random access procedure failed and re-initialize the random access procedure.

In some examples, high Dopplers in the range of subcarrier spacing may cause a cyclic shift in received PRACH preamble sequences, dependent on the root. For example, for a root u, a ZC sequence may be shifted by ±idᵤ, where i is an integer with value of 1 or 2, depending on the Doppler, and

$${d}_{u} = \{ \begin{matrix}q if 0 \leq q < L / 2 \\ L - q if q \geq L 2\end{matrix} and ( qu ) mod L = 1 \qquad ( Equation 3 )$$

where L is length of the ZC sequence. Thus, ±idᵤ represents a measure of the Doppler shift and is a function of the root u. The ZC cyclic shift due to the Doppler shift is in addition to the delay shift (N_{CS}) due to the RTT (e.g., the propagation delay). To accommodate both the delay shift (N_{CS}) and the Doppler shift (±idᵤ), PRACH restricted cyclic shift sets may be defined.

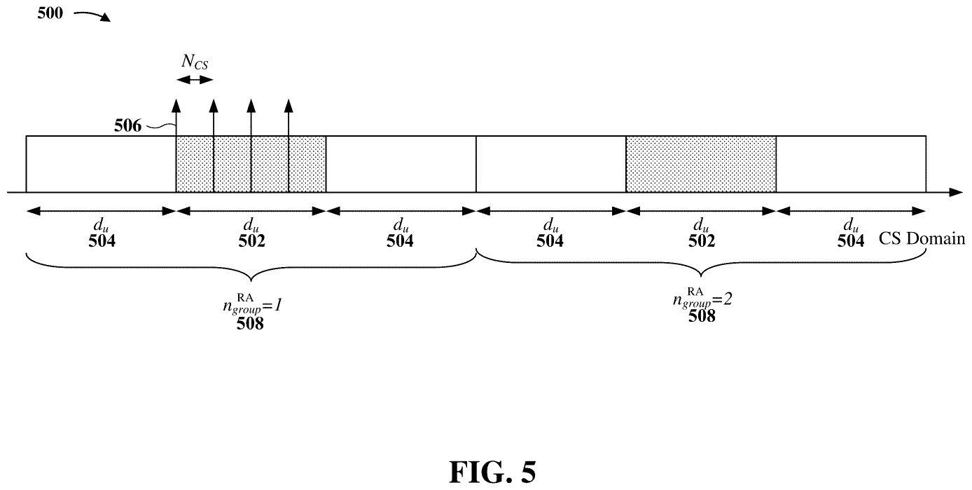

FIG. 5 is a diagram illustrating an example of a PRACH restricted cyclic shift configuration 500 to manage higher Doppler cases according to some aspects. In the example shown in FIG. 5, cyclic shifts are depicted in a cyclic shift (CS) domain (along the x-axis) for a root u. The cyclic shifts are divided into allowed cyclic shift ranges 502 and restricted cyclic shift ranges 504. Each cyclic shift range 502 and 504 includes a consecutive set of cyclic shifts within a Doppler shift range (dᵤ) of the root. The allowed cyclic shift range 502 includes an allowed set of cyclic shifts 506, whereas the restricted cyclic shift ranges 504 include prohibited cyclic shifts that are prohibited from being selected for a PRACH preamble message.

A respective restricted cyclic shift range 504 is configured adjacent to each allowed cyclic shift range 502 on either side thereof. The restricted cyclic shift ranges 504 are configured to provide a gap of dᵤ on each side of the allowed cyclic shift range 502 to allow for Doppler shifts of ±idᵤ from each allowed cyclic shift 506 within the allowed cyclic shift range 502. Thus, the restricted cyclic shift ranges 504 form guard cyclic shift ranges on either side of the allowed cyclic shift range 502.

In the example shown in FIG. 5, the cyclic shifts are further grouped into cyclic shift groups

$$( {n}_{group}^{RA} )$$

508 with each cyclic shift group 508 including a respective allowed cyclic shift range 502 and respective corresponding restricted cyclic shift ranges 504 on either side of the respective allowed cyclic shift range 502 Each cyclic shift group 508 corresponds to a random access (RA) group, which may be referenced by an RA group index

$$( e . g . , {n}_{group}^{RA} = 1 , {n}_{group}^{RA} = 2 , etc . ) .$$

Each RA group 508 thus includes a set of possible PRACH random access preambles corresponding to the allowed cyclic shifts 506. The PRACH restricted cyclic shift configuration 500 shown in FIG. 5 is referred to herein as a Type A PRACH restricted set configuration, which includes a single restricted cyclic shift range 504 on either side of the allowed cyclic shift range 502. A Type B PRACH restricted set configuration is also possible, which includes an additional restricted cyclic shift range on either side of the allowed cyclic shift range to accommodate higher Dopplers (e.g., where i=2).

The allowed cyclic shifts 506 are spaced (separated) by a nominal cyclic shift step size (N_{CS}) that is greater than or equal to the maximum RTT in a serving cell for the PRACH restricted cyclic configuration 500. Therefore, based on the nominal cyclic shift step size (N_{CS}), within each cyclic shift group 508, only a certain number of cyclic shifts

$$( {n}_{shift}^{RA} )$$

are allowed to support the Doppler shifts of ±dᵤ. For example, for a Type A restricted set with dᵤ<L/3, the number of cyclic shifts 506 per cyclic shift group 508 may be determined as:

$$\begin{matrix}{n}_{shift}^{RA} = ⌊ {d}_{u} / {N}_{CS} ⌋ , {d}_{start} \\ = 2 {d}_{u} + {n}_{shift}^{RA} {N}_{CS} , {n}_{group}^{RA} \\ = ⌊ L / {d}_{start} ⌋ , {\hat{n}}_{shift}^{RA} \\ = max ( ⌊ L - 2 {d}_{u} - \frac{{n}_{group}^{RA} {d}_{start}}{{N}_{CS}} ⌋ , 0 )\end{matrix} \qquad ( Equation 4 )$$

Here, dₛₜₐᵣₜ represents the number of cyclic shifts within each

$${n}_{group}^{RA} ,$$

including allowed and restricted cyclic shifts. Thus, based on dₛₜₐᵣₜ, the number of cyclic shift groups for a root can be determined.

However, for either a normal PRACH cyclic shift configuration (as described in FIG. 4) or a restricted set PRACH cyclic shift configuration (as shown in FIG. 5), in some cases, the network entity may be unable to differentiate between multiple received preambles or transmitting UEs. For example, if two (or more) UEs inadvertently select a same preamble sequence and a same cyclic shift to transmit respective preambles, and if—after corresponding propagation delays—both preambles arrive at the network entity at a same or similar arrival time (thus, the same TA), the preambles may be indistinguishable in the time domain, which may be referred to as a time domain collision. Put another way, the two preambles may appear to the network entity as a single signal. In another example, the network entity may incorrectly detect cyclic shifts for each preamble. For instance, the cyclic shift step size may be suboptimal such that multiple cyclic shifts may correspond to a single detected cyclic shift, or the detected cyclic shift for multiple preambles may appear to be the same after accounting for respective propagation delays. In this case, there will be a collision in the msg3 transmission, and the UE may need to retransmit msg1 in the next RACH occasion (RO). As the number of UEs served by the network entity increases, the likelihood that multiple UEs select a same preamble sequence, a same cyclic shift, or both, may also increase, thereby increasing the likelihood of collisions between preambles.

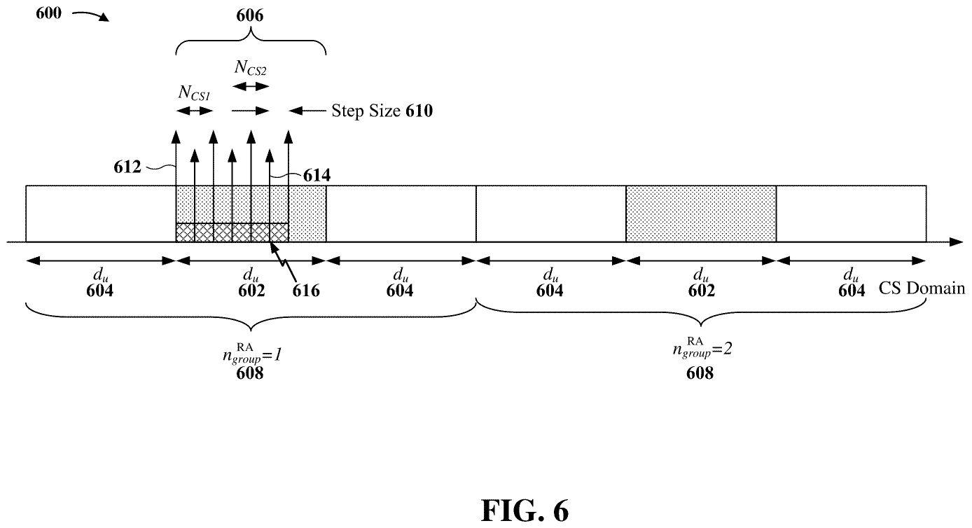

FIG. 6 is a diagram illustrating an example of an over-provisioned cyclic shift configuration 600 for PRACH restricted sets according to some aspects. In the example shown in FIG. 6, cyclic shifts are depicted in a cyclic shift (CS) domain (along the x-axis) for a root u. Thus, the over-provisioned cyclic shift configuration 600 shown in FIG. 6 is configured for a particular preamble root sequence (for root u). It should be understood that respective over-provisioned cyclic shift configurations similar to that shown in FIG. 6 may be configured for each preamble root sequence of a plurality of available preamble root sequences in the serving cell.

The cyclic shifts are divided into allowed cyclic shift ranges 602 and restricted cyclic shift ranges 604. Each cyclic shift range 602 and 604 includes a consecutive set of cyclic shifts within a Doppler shift range (dᵤ) of the root. The allowed cyclic shift range 602 includes an allowed set of cyclic shifts 606, whereas the restricted cyclic shift ranges 604 include prohibited cyclic shifts that are prohibited from being selected for a PRACH preamble message. A respective restricted cyclic shift range 604 is configured adjacent to each allowed cyclic shift range 602 on either side thereof. The restricted cyclic shift ranges 604 are configured to provide a gap of dᵤ on each side of the allowed cyclic shift range 602 to allow for Doppler shifts of ±dᵤ from each allowed cyclic shift 606 within the allowed cyclic shift range 602. Thus, the restricted cyclic shift ranges 604 form guard cyclic shift ranges on either side of the allowed cyclic shift range 602.

The cyclic shifts are further grouped into cyclic shift groups

$$( {n}_{group}^{RA} )$$

608 with each cyclic shift group 608 including a respective allowed cyclic shift range 602 and respective corresponding restricted cyclic shift ranges 604 on either side of the respective allowed cyclic shift range 602. Each cyclic shift group 608 corresponds to a random access (RA) group, which may be referenced by an RA group index

$$( e . g . , {n}_{group}^{RA} = 1 , {n}_{group}^{RA} = 2 , etc . )$$

Each RA group 608 thus includes a set of possible PRACH random access preambles corresponding to the allowed cyclic shifts 606.

In the example shown in FIG. 6, the allowed cyclic shifts 606 are spaced (separated) by a cyclic shift step size 610 that is less than the maximum RTT of the serving cell associated with the over-provisioned cyclic shift configuration 600. The allowed cyclic shifts 606 include a first set of cyclic shifts 612 that are spaced by a nominal cyclic shift step size (N_{CS1}) that is greater than or equal to the maximum RTT in the serving cell and a second set of cyclic shifts 614 that are separated by a second cyclic shift step size (N_{CS2}) offset from the first cyclic shift step size (N_{CS1}). The offset between the first cyclic shift step size (N_{CS1}) and the second cyclic shift step size (N_{CS2}) is less than the maximum RTT such that the overall cyclic shift step size 610 is less than the maximum RTT.

In some examples, as shown in FIG. 6, the second cyclic shift step size (N_{CS2}) may be the same as the first cyclic shift step size (N_{CS1}), thus producing an overall cyclic shift step size 610 of N_{CS1}/2. In other examples, the second cyclic shift step size (N_{CS2}) may be different than the first cyclic shift step size (N_{CS1}). For example, the first step size (N_{CS1}) may correspond to a respective cyclic shift duration of each of the first set of cyclic shifts 612. The second cyclic shift step size (N_{CS2}) of the second set of cyclic shifts 614 within each of the respective cyclic shift durations (e.g., N_{CS1}) may be configured to be less than the maximum RTT, thus producing an overall cyclic shift step size 610 less than N_{CS1}/2 (e.g., N_{CS1}/3, N_{CS1}/4, . . . , N_{CS1}/N).

In some examples, the second set of cyclic shifts 614 may be configured within a cyclic shift region 616 that includes the respective cyclic shift durations (e.g., N_{CS1}) of each of the first set of cyclic shifts 612 excluding a last cyclic shift of the first set of cyclic shifts 612 within the allowed cyclic shift range 602. Thus, for an over-provisioned cyclic shift configuration 600, the network entity can assign a higher number of cyclic shifts only within the cyclic shift durations of the first

$$( {n}_{shift}^{RA} - 1 )$$

cyclic shifts of each

$${n}_{group}^{RA}$$

corresponding to the cyclic shift region 616 from the first cyclic shift of

$${n}_{shift}^{RA}$$

to the last cyclic shift of

$${n}_{shift}^{RA} .$$

If the network entity allocated over-provisioned cyclic shifts beyond the last cyclic shift of

$${n}_{shift}^{RA} ,$$

the received path corresponding to that cyclic shift may be detected by the network entity at the Doppler region corresponding to the negative restricted region of the next cyclic shift group 608

$$( e . g . , {n}_{group}^{RA} = 2 ) ,$$

which may collide with the preamble transmitted at the first cyclic shift of

$${n}_{shift}^{RA}$$

of the allowed cyclic shift range 602 of the next cyclic shift group 608

$$( e . g . , {n}_{group}^{RA} = 2 ) .$$

In some examples, the allowed cyclic shifts 606 can include a range of cyclic shifts within the cyclic shift region 616. For example, the network entity can allocate a respective range of cyclic shifts within each of the respective cyclic shift durations of the first set of cyclic shifts 612. As another example, the network entity can allocate all cyclic shifts within the cyclic shift region 616 (e.g., all cyclic shifts within the respective cyclic shift durations of the first set of cyclic shifts 612 excluding the last cyclic shift of the first set of cyclic shifts). In some examples, the allowed cyclic shifts 606 can include individual cyclic shifts within the cyclic shift region 616. For example, the network entity can allocate individual cyclic shifts within the respective cyclic shift durations of the first set of cyclic shifts 612 excluding the last cyclic shift of the first set of cyclic shifts. In this example, the network entity may allocate individual cyclic shifts such that the overall cyclic shift step size 610 between the allowed cyclic shifts 606 is a fraction of the maximum RTT.

In some examples, the over-provisioned restricted cyclic shift configuration 600 can be configured such that a respective range or set of allowed cyclic shifts 606 is defined within each cyclic shift group 608. For example, the range or set of allowed cyclic shifts 606 can be the same for each cyclic shift group 608 or may differ between cyclic shift groups 608.

The over-provisioned restricted cyclic shift configuration 600 shown in FIG. 6 is referred to herein as a Type A PRACH restricted set configuration, which includes a single restricted cyclic shift range 604 on either side of the allowed cyclic shift range 602. A Type B PRACH restricted set configuration is also possible, which includes additional restricted cyclic shift range(s) on either side of the allowed cyclic shift range to accommodate higher Dopplers (e.g., where i≥2).

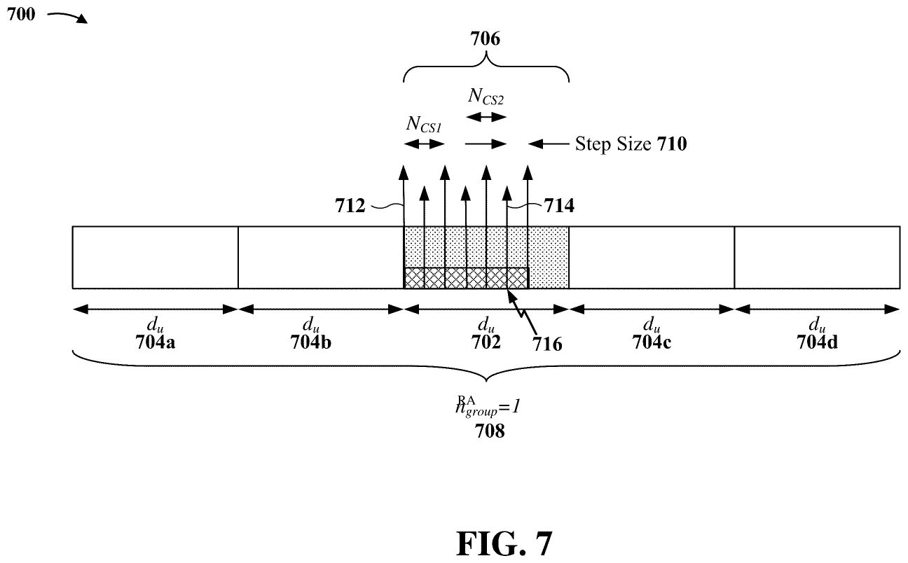

FIG. 7 is a diagram illustrating another example of an over-provisioned cyclic shift configuration 700 for PRACH restricted sets according to some aspects. In the example shown in FIG. 6, cyclic shifts are depicted in a cyclic shift (CS) domain (along the x-axis) for a root u. The cyclic shifts are divided into allowed cyclic shift ranges 702 and restricted cyclic shift ranges 704a-704d. Each cyclic shift range 702 and 704a-704d includes a consecutive set of cyclic shifts within a Doppler shift range (dᵤ) of the root. The allowed cyclic shift range 702 includes an allowed set of cyclic shifts 706, whereas the restricted cyclic shift ranges 704a-704d include prohibited cyclic shifts that are prohibited from being selected for a PRACH preamble message.

In the example shown in FIG. 7, two restricted cyclic shift ranges 704a/704b and 704c/704d are configured adjacent to each allowed cyclic shift range 702 on either side thereof. The restricted cyclic shift ranges 704a-704d are configured to provide a gap of 2dᵤ on each side of the allowed cyclic shift range 702 to allow for Doppler shifts of ±2dᵤ from each allowed cyclic shift 706 within the allowed cyclic shift range 702. Thus, the restricted cyclic shift ranges 704a-704d form guard cyclic shift ranges on either side of the allowed cyclic shift range 702. It should be understood that the guard cyclic shift ranges (704a/704b and 704c/704d) may provide a gap of greater than ±d_ᵤ on either side, but is not limited to the specific configuration of ±2dᵤ shown in FIG. 7.

The cyclic shifts may further be grouped into cyclic shift groups

$$( {n}_{group}^{RA} )$$

708 with each cyclic shift group 708 including a respective allowed cyclic shift range 702 and respective corresponding restricted cyclic shift ranges 704a-704d on either side of the respective allowed cyclic shift range 702. Each cyclic shift group 708 corresponds to a random access (RA) group (only one of which is shown in FIG. 7), which may be referenced by an RA group index

$$( e . g . , {n}_{group}^{RA} = 1 , etc . ) .$$

Each RA group 708 thus includes a set of possible PRACH random access preambles corresponding to the allowed cyclic shifts 706.

The allowed cyclic shifts 706 are spaced (separated) by a cyclic shift step size 710 that is less than the maximum RTT of the serving cell associated with the over-provisioned cyclic shift configuration 700. In some examples, the allowed cyclic shifts 706 include a first set of cyclic shifts 712 that are spaced by a nominal cyclic shift step size (N_{CS1}) that is greater than or equal to the maximum RTT in the serving cell and a second set of cyclic shifts 714 that are separated by a second cyclic shift step size (N_{CS2}) offset from the first cyclic shift step size (N_{CS1}). The offset between the first cyclic shift step size (N_{CS1}) and the second cyclic shift step size (N_{CS2}) is less than the maximum RTT such that the overall cyclic shift step size 710 is less than the maximum RTT.

In some examples, the second set of cyclic shifts 714 may be configured within a cyclic shift region 716 that includes the respective cyclic shift durations (e.g., N_{CS1}) of each of the first set of cyclic shifts 712 excluding a last cyclic shift of the first set of cyclic shifts 712 within the allowed cyclic shift range 702. For example, the allowed cyclic shifts 706 can include a range of cyclic shifts within the cyclic shift region 716. In this example, the allowed cyclic shifts 706 can include a respective range of cyclic shifts within each of the respective cyclic shift durations of the first set of cyclic shifts 712 or all cyclic shifts within the cyclic shift region 716 (e.g., all cyclic shifts within the respective cyclic shift durations of the first set of cyclic shifts 712 excluding the last cyclic shift of the first set of cyclic shifts). As another example, the allowed cyclic shifts 706 can include individual cyclic shifts within the cyclic shift region 716. For example, the allowed cyclic shifts 706 can include individual cyclic shifts such that the overall cyclic shift step size 710 between the allowed cyclic shifts 706 is a fraction of the maximum RTT.

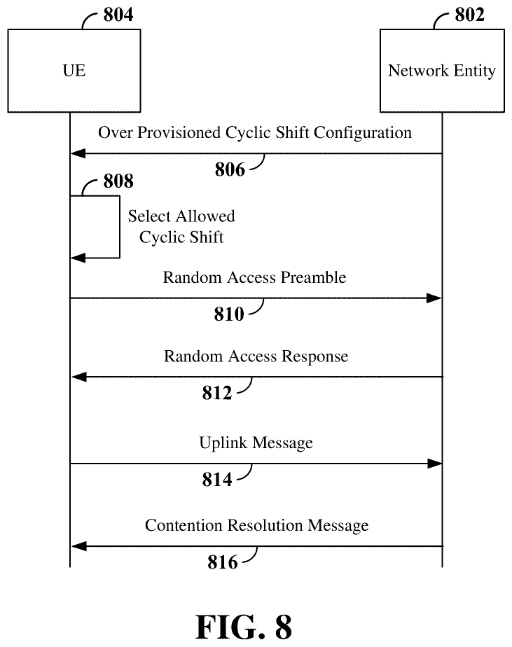

FIG. 8 is a diagram illustrating an example of a random access procedure using an over-provisioned cyclic shift configuration according to some aspects. The random access procedure shown in FIG. 8 is a 4-step contention-based random access (CBRA) procedure 800 between a network entity 802 and a UE 804. The network entity 802 may correspond, for example, to any of the network entities shown in FIGS. 1, 2, and/or 4. In addition, the UE 804 may correspond, for example, to any of the UEs shown in FIGS. 1, 2, and/or 4.

The network entity 802 can send an over-provisioned cyclic shift configuration 806 to the UE 804 within, for example, a SIB (e.g., SIB1 and/or SIB2). The over-provisioned cyclic shift configuration may include a respective over-provisioned cyclic shift configuration for each of a plurality of preamble root sequences (e.g., for each root u). The over-provisioned cyclic shift configuration 806 for each preamble root sequence may be a PRACH restricted set configuration that include a respective allowed cyclic shift range including an allowed set of cyclic shifts associated with a cyclic shift step size less than a maximum round trip time (RTT) of a cell associated with the network entity 802 and corresponding restricted cyclic shift ranges adjacent to the allowed cyclic shift range on either side thereof.

In some examples, the over-provisioned cyclic shift configuration 806 may include a range of allowed cyclic shifts within the allowed cyclic shift range or individual allowed cyclic shifts within the allowed cyclic shift range. For example, the over-provisioned cyclic shift configuration 806 may indicate that all cyclic shifts within a cyclic shift region of the allowed cyclic shift range may be selected. As another example, the over-provisioned cyclic shift configuration 806 may indicate that N_{CS}/x cyclic shifts within the cyclic shift region of the allowed cyclic shift range may be selected, where x is an integer greater than or equal to two.

At 808, the UE 804 can randomly select a preamble root sequence and corresponding allowed cyclic shift based on the over-provisioned cyclic shift configuration 806. In an example, the UE 804 may select from 64 possible preamble sequences for inclusion in the RACH preamble message 810. The UE 804 may further select an allowed cyclic shift from the allowed set of cyclic shifts associated with the selected preamble sequence in the over-provisioned cyclic shift configuration 806. The UE 804 can then transmit the selected preamble to the network entity 802 in a RACH preamble message 810 (msg1).

If the preamble is successfully detected by the network entity 802, the network entity 802 transmits a random access response (RAR) message 812 (msg2) including a PDCCH and PDSCH to the UE 804. The msg2 812 (PDCCH+PDSCH) includes an identifier of the preamble sent by the UE 804, a Timing Advance (TA) (e.g., based on the detected propagation delay), a temporary cell radio network temporary identifier (TC-RNTI) or random access (RA) RNTI for the UE 804 and a grant of assigned uplink (UL) resources. The PDCCH in msg2 812 may be scrambled with the RA-RNTI, which is a function of a RACH occasion (RO) (e.g., time-frequency resources allocated for RACH msg1) that the UE 804 used to send msg1 810. A medium access control—control element (MAC-CE) within the PDSCH provides an acknowledgement of the reception of msg1 and the UL grant. To receive msg2 812, the UE 804 may monitor DCI 1_0 for the PDCCH scrambled with the RA-RNTI corresponding to the RO used by the UE 804 to transmit msg1 810, and if detected, proceeds with PDSCH decoding. Upon receipt of the RAR message 812, the UE 804 compares the preamble ID to the preamble sent by the scheduled entity in the RACH preamble message 810. If the preamble ID matches the preamble sent in the RACH preamble message 806, the UE 804 applies the timing advance and starts a contention resolution procedure.

During contention resolution, the UE 804 transmits an uplink message (msg3) 814 on the common control channel (CCCH) using the TA and assigned uplink resources in the PDSCH of msg2 812. In an example, the uplink message 814 is a Layer 2/Layer 3 (L2/L3) message, such as a Radio Resource Control (RRC) Connection Request message. The uplink message 814 includes an identifier of the UE 804 (UE-ID) for use by the network entity 802 in resolving any collisions. Upon successfully decoding the uplink message, the network entity 802 transmits a contention resolution message 816 to the UE 804 (msg4). The contention resolution message 816 may be, for example, an RRC-Connection Setup message. In addition, the contention resolution message 816 includes the identifier of the UE 804 that was received in the uplink message 814. The UE 804, upon receiving its own identity back in the contention resolution message 816, concludes that the random access procedure was successful and completes the RRC connection setup process.

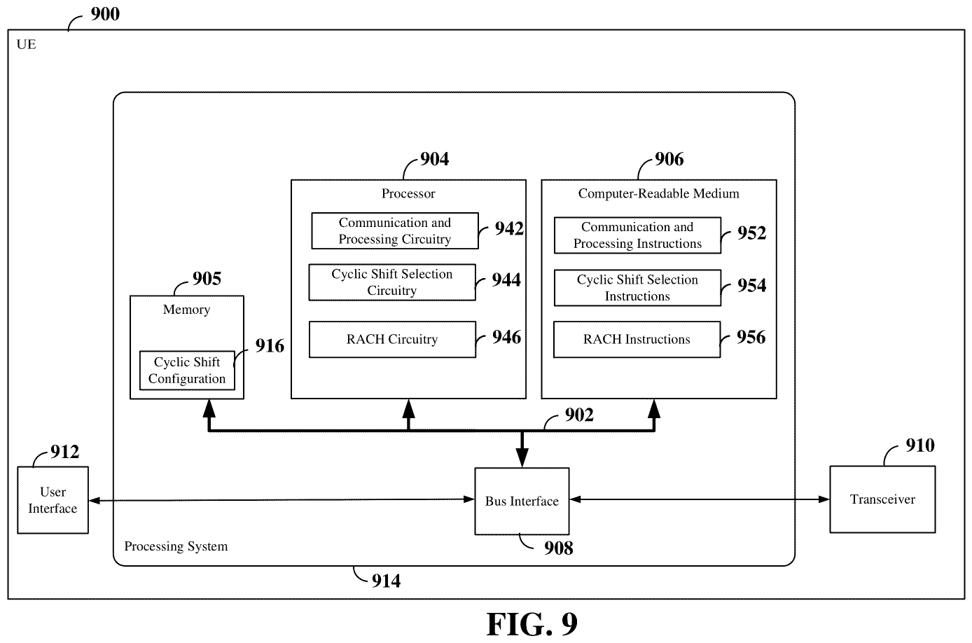

FIG. 9 is a block diagram illustrating an example of a hardware implementation for a user equipment (UE) employing a processing system 914. For example, the UE 900 may correspond to any of the UEs shown and described above in reference to FIGS. 1, 2, 4 and/or 8.

The UE 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 900 may be configured to perform any one or more of the functions described herein. That is, the processor 904, as utilized in the UE 900, may be used to implement any one or more of the processes and procedures described below.

The processor 904 may in some instances be implemented via a baseband or modem chip and in other implementations, the processor 904 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902, an optional user interface 912, and at least one transceiver 910. The transceiver 910 provides a means for communicating with various other apparatus over a transmission medium (e.g., air interface).

The processor 904 is responsible for managing the bus 902 and general processing, including the execution of software stored on the computer-readable medium 906. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 904, causes the processing system 914 to perform the various functions described below for any particular apparatus. The computer-readable medium 906 and the memory 905 may also be used for storing data that is utilized by the processor 904 when executing software. For example, the memory 905 may store one or more of a cyclic shift configuration 916. The cyclic shift configuration 916 may be, for example, an over-provisioned cyclic shift configuration 916 for PRACH restricted sets.

The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. In some examples, the computer-readable medium 906 may be part of the memory 905. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include communication and processing circuitry 942, configured to communicate with a network entity (e.g., an aggregated or disaggregated base station, such as a gNB or eNB). In some examples, the communication and processing circuitry 942 may include one or more hardware components that provide the physical structure that performs processes related to wireless communication (e.g., signal reception and/or signal transmission) and signal processing (e.g., processing a received signal and/or processing a signal for transmission). In some examples, the communication and processing circuitry 942 may include low complexity circuitry for baseband or near-baseband processing with minimal RF processing.

In some implementations where the communication involves receiving information, the communication and processing circuitry 942 may receive a signal from a component of the UE 900 (e.g., from the transceiver 910 that receives the information via radio frequency signaling or some other type of signaling suitable for the applicable communication medium), process (e.g., decode) the information, and output the processed information. For example, the communication and processing circuitry 942 may output the information to another component of the processor 904, to the memory 905, or to the bus interface 908. In some examples, the communication and processing circuitry 942 may receive one or more of signals, messages, other information, or any combination thereof. In some examples, the communication and processing circuitry 942 may receive information via one or more channels. In some examples, the communication and processing circuitry 942 may include functionality for a means for receiving. In some examples, the communication and processing circuitry 942 may include functionality for a means for processing, including a means for demodulating, a means for decoding, etc.

In some implementations where the communication involves sending (e.g., transmitting) information, the communication and processing circuitry 942 may obtain information (e.g., from another component of the processor 904, the memory 905, or the bus interface 908), process (e.g., modulate, encode, etc.) the information, and output the processed information. For example, the communication and processing circuitry 942 may output the information to the transceiver 910 (e.g., that transmits the information via radio frequency signaling or some other type of signaling suitable for the applicable communication medium). In some examples, the communication and processing circuitry 942 may send one or more of signals, messages, other information, or any combination thereof. In some examples, the communication and processing circuitry 942 may send information via one or more channels. In some examples, the communication and processing circuitry 942 may include functionality for a means for sending (e.g., a means for transmitting). In some examples, the communication and processing circuitry 942 may include functionality for a means for generating, including a means for modulating, a means for encoding, etc.

In some examples, the communication and processing circuitry 942 may be configured to receive a cyclic shift configuration 916 for a preamble root sequence from a network entity (e.g., aggregated or disaggregated gNB). The cyclic shift configuration can include an allowed cyclic shift range including an allowed set of cyclic shifts associated with a cyclic shift step size less than a maximum round trip time (RTT) of a cell associated with the network entity. The cyclic shift configuration can further include corresponding restricted cyclic shift ranges adjacent to the allowed cyclic shift range on either side thereof. The cyclic shift configuration 916 may be stored, for example, in memory 905.

In some examples, the allowed set of cyclic shifts include a first set of cyclic shifts having a first cyclic shift step size equal to or greater than the maximum RTT and a second set of cyclic shifts within a cyclic shift region that includes respective cyclic shift durations of the first set of cyclic shifts excluding a last cyclic shift of the first set of cyclic shifts. In some examples, the second set of cyclic shifts includes a second cyclic shift step size offset from the first cyclic shift step size, where the offset is less than the maximum RTT. In some examples, the second cyclic shift step size within each of the respective cyclic shift durations is less than the maximum RTT. In some examples, the allowed set of cyclic shifts includes a respective range of cyclic shifts within the respective cyclic shift durations of the first set of cyclic shifts excluding the last cyclic shift of the first set of cyclic shifts. In some examples, the respective range of cyclic shifts includes all cyclic shifts within the respective cyclic shift durations of the first set of cyclic shifts excluding the last cyclic shift of the first set of cyclic shifts. In some examples, the allowed set of cyclic shifts includes individual cyclic shifts within the respective cyclic shift durations of the first set of cyclic shifts excluding the last cyclic shift of the first set of cyclic shifts, where the cyclic shift step size between the individual cyclic shifts is a fraction of the maximum RTT.

In some examples, the cyclic shift configuration includes at least two cyclic shift groups, where each of the cyclic shift groups includes a respective allowed cyclic shift range and respective corresponding restricted cyclic shift ranges for the corresponding cyclic shift group. In some examples, the communication and processing circuitry 942 is configured to receive a respective cyclic shift configuration for each preamble root sequence of a plurality of preamble root sequences, each including a respective allowed cyclic shift range with a respective cyclic shift step size less than the maximum RTT and respective corresponding restricted cyclic shift ranges adjacent to the allowed cyclic shift range on either side thereof. In some examples, each of the restricted cyclic shift ranges corresponds to a first Doppler shift range or a second Doppler shift range greater than the first Doppler shift range.

The communication and processing circuitry 942 may further be configured to transmit a random access preamble message to the network entity based on the cyclic shift configuration 916. The communication and processing circuitry 942 may further be configured to execute communication and processing instructions (software) 952 stored in the computer-readable medium 906 to implement one or more of the functions described herein.

The processor 904 may further include cyclic shift selection circuitry 944, configured to select an allowed cyclic shift from the allowed set of cyclic shifts based on the over-provisioned cyclic shift configuration 916. The cyclic shift selection circuitry 944 may further be configured to execute cyclic shift selection instructions (software) 954 stored in the computer-readable medium 906 to implement one or more of the functions described herein.

The processor 904 may further include RACH circuitry 946, configured to generate the random access preamble message using the selected allowed cyclic shift for transmission to the network entity (e.g., via the communication and processing circuitry 942 and transceiver 910). The RACH circuitry 946 may further be configured to perform a RACH procedure, as shown for example in FIGS. 4 and/or 8. The RACH circuitry 946 may further be configured to execute RACH instructions (software) 956 stored in the computer-readable medium 906 to implement one or more of the functions described herein.

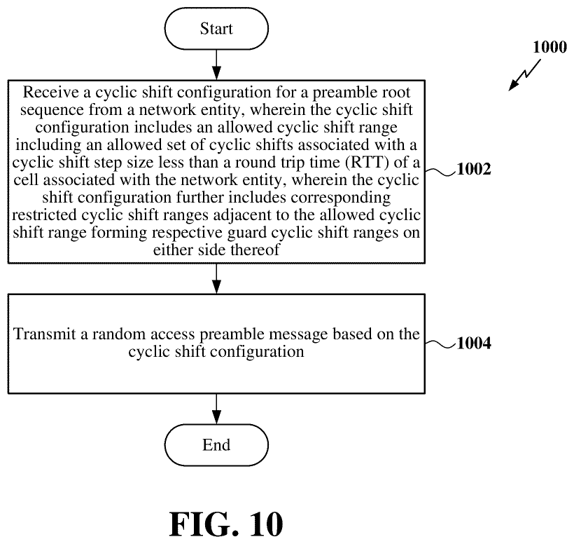

FIG. 10 is a flow chart of an exemplary process 1000 for initiating a random access procedure using an over-provisioned cyclic shift configuration according to some aspects. As described below, some or all illustrated features may be omitted in a particular implementation within the scope of the present disclosure, and some illustrated features may not be required for implementation of all examples. In some examples, the method may be performed by the UE 900, as described above and illustrated in FIG. 9, by a processor or processing system, or by any suitable means for carrying out the described functions.

At block 1002, the UE may receive a cyclic shift configuration for a preamble root sequence from a network entity. The cyclic shift configuration can include an allowed cyclic shift range including an allowed set of cyclic shifts associated with a cyclic shift step size less than a maximum round trip time (RTT) of a cell associated with the network entity. The cyclic shift configuration can further include corresponding restricted cyclic shift ranges adjacent to the allowed cyclic shift range on either side thereof. For example, the communication and processing circuitry 942 in connection with the transceiver 910, shown and described above in connection with FIG. 9, may provide a means to receive the cyclic shift configuration.

In some examples, the allowed set of cyclic shifts include a first set of cyclic shifts having a first cyclic shift step size equal to or greater than the maximum RTT and a second set of cyclic shifts within a cyclic shift region that includes respective cyclic shift durations of the first set of cyclic shifts excluding a last cyclic shift of the first set of cyclic shifts. In some examples, the second set of cyclic shifts includes a second cyclic shift step size offset from the first cyclic shift step size, where the offset is less than the maximum RTT. In some examples, the second cyclic shift step size within each of the respective cyclic shift durations is less than the maximum RTT. In some examples, the allowed set of cyclic shifts includes a respective range of cyclic shifts within the respective cyclic shift durations of the first set of cyclic shifts excluding the last cyclic shift of the first set of cyclic shifts. In some examples, the respective range of cyclic shifts includes all cyclic shifts within the respective cyclic shift durations of the first set of cyclic shifts excluding the last cyclic shift of the first set of cyclic shifts. In some examples, the allowed set of cyclic shifts includes individual cyclic shifts within the respective cyclic shift durations of the first set of cyclic shifts excluding the last cyclic shift of the first set of cyclic shifts, where the cyclic shift step size between the individual cyclic shifts is a fraction of the maximum RTT.

In some examples, the cyclic shift configuration includes at least two cyclic shift groups, where each of the cyclic shift groups includes a respective allowed cyclic shift range and respective corresponding restricted cyclic shift ranges for the corresponding cyclic shift group. In some examples, the communication and processing circuitry 942 is configured to receive a respective cyclic shift configuration for each preamble root sequence of a plurality of preamble root sequences, each including a respective allowed cyclic shift range with a respective cyclic shift step size less than the maximum RTT and respective corresponding restricted cyclic shift ranges adjacent to the allowed cyclic shift range on either side thereof. In some examples, each of the restricted cyclic shift ranges corresponds to a first Doppler shift range or a second Doppler shift range greater than the first Doppler shift range.

At block 1004, the UE may transmit a random access preamble message based on the cyclic shift configuration. For example, the communication and processing circuitry 942, together with the transceiver 910, shown and described above in connection with FIG. 9, may provide a means to transmit the random access preamble message.

In some examples, the UE may select an allowed cyclic shift from the allowed set of cyclic shifts. The UE may further transmit the random access preamble message using the allowed cyclic shift. In sone examples, the restricted cyclic shift ranges comprise prohibited cyclic shifts prohibited from being selected for the random access preamble message.

In one configuration, the UE 900 includes means for wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof, and means for transmitting a random access preamble message based on the cyclic shift configuration. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, and/or 9 utilizing, for example, the processes and/or algorithms described herein in relation to FIGS. 4, 8, and/or 10.

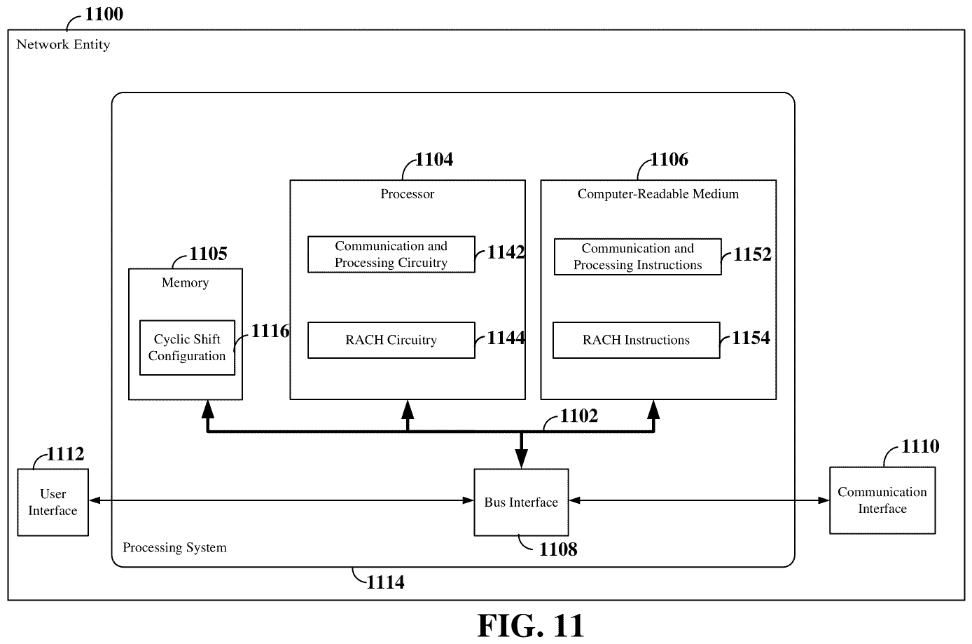

FIG. 11 is a block diagram illustrating an example of a hardware implementation for an exemplary network entity 1100 employing a processing system 1114. For example, the network entity 1100 may correspond to any of the network entities (e.g., aggregated or disaggregated base stations) shown in any one or more of FIGS. 1, 2, 4, and/or 8.

In accordance with various aspects of the disclosure, an element, or any portion of an element, or any combination of elements may be implemented with a processing system 1114 that includes one or more processors 1104. The processing system 1114 may be substantially the same as the processing system 1514 illustrated in FIG. 9, including a bus interface 1108, a bus 1102, memory 1105, a processor 1104, and a computer-readable medium 1106. Furthermore, the network entity 1100 may include an optional user interface 1112 and a communication interface (e.g., a transceiver and one or more antenna arrays or a network interface). The processor 1104, as utilized in a network entity 1100, may be used to implement any one or more of the processes described herein. In some examples, the memory 1105 may store one or more of a cyclic shift configuration 1116 that may be utilized by the processor 1104 when executing software.

The processor 1104 may include communication and processing circuitry 1142 configured to communicate with one or more UEs or other network entities. In some examples, the communication and processing circuitry 1142 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1142 may include one or more transmit/receive chains.

In some implementations where the communication involves receiving information, the communication and processing circuitry 1142 may obtain information from a component of the network entity 1100 (e.g., from the communication interface 1110 that receives the information via radio frequency signaling or some other type of signaling suitable for the applicable communication medium), process (e.g., decode) the information, and output the processed information. For example, the communication and processing circuitry 1142 may output the information to another component of the processor 1104, to the memory 1105, or to the bus interface 1108. In some examples, the communication and processing circuitry 1142 may receive one or more of signals, messages, other information, or any combination thereof. In some examples, the communication and processing circuitry 1142 may receive information via one or more channels. In some examples, the communication and processing circuitry 1142 may include functionality for a means for receiving. In some examples, the communication and processing circuitry 1142 may include functionality for a means for processing, including a means for demodulating, a means for decoding, etc.

In some implementations where the communication involves sending (e.g., transmitting) information, the communication and processing circuitry 1142 may obtain information (e.g., from another component of the processor 1104, the memory 1105, or the bus interface 1108), process (e.g., modulate, encode, etc.) the information, and output the processed information. For example, the communication and processing circuitry 1142 may output the information to the communication interface 1110 (e.g., that transmits the information via radio frequency signaling or some other type of signaling suitable for the applicable communication medium). In some examples, the communication and processing circuitry 1142 may send one or more of signals, messages, other information, or any combination thereof. In some examples, the communication and processing circuitry 1142 may send information via one or more channels. In some examples, the communication and processing circuitry 1142 may include functionality for a means for sending (e.g., a means for transmitting). In some examples, the communication and processing circuitry 1142 may include functionality for a means for generating, including a means for modulating, a means for encoding, etc.

The communication and processing circuitry 1142 may be configured to provide a cyclic shift configuration 1116 for a preamble root sequence to at least one user equipment (UE). The cyclic shift configuration 1116 can include an allowed cyclic shift range including an allowed set of cyclic shifts associated with a cyclic shift step size less than a maximum round trip time (RTT) of a cell associated with the network entity. The cyclic shift configuration 1116 can further include corresponding restricted cyclic shift ranges adjacent to the allowed cyclic shift range on either side thereof. The cyclic shift configuration 1116 may be stored, for example, in memory 1105.

In some examples, the allowed set of cyclic shifts include a first set of cyclic shifts having a first cyclic shift step size equal to or greater than the maximum RTT and a second set of cyclic shifts within a cyclic shift region that includes respective cyclic shift durations of the first set of cyclic shifts excluding a last cyclic shift of the first set of cyclic shifts. In some examples, the second set of cyclic shifts includes a second cyclic shift step size offset from the first cyclic shift step size, where the offset is less than the maximum RTT. In some examples, the second cyclic shift step size within each of the respective cyclic shift durations is less than the maximum RTT. In some examples, the allowed set of cyclic shifts includes a respective range of cyclic shifts within the respective cyclic shift durations of the first set of cyclic shifts excluding the last cyclic shift of the first set of cyclic shifts. In some examples, the respective range of cyclic shifts includes all cyclic shifts within the respective cyclic shift durations of the first set of cyclic shifts excluding the last cyclic shift of the first set of cyclic shifts. In some examples, the allowed set of cyclic shifts includes individual cyclic shifts within the respective cyclic shift durations of the first set of cyclic shifts excluding the last cyclic shift of the first set of cyclic shifts, where the cyclic shift step size between the individual cyclic shifts is a fraction of the maximum RTT.

In some examples, the cyclic shift configuration includes at least two cyclic shift groups, where each of the cyclic shift groups includes a respective allowed cyclic shift range and respective corresponding restricted cyclic shift ranges for the corresponding cyclic shift group. In some examples, the communication and processing circuitry 1142 is configured to receive a respective cyclic shift configuration for each preamble root sequence of a plurality of preamble root sequences, each including a respective allowed cyclic shift range with a respective cyclic shift step size less than the maximum RTT and respective corresponding restricted cyclic shift ranges adjacent to the allowed cyclic shift range on either side thereof. In some examples, each of the restricted cyclic shift ranges corresponds to a first Doppler shift range or a second Doppler shift range greater than the first Doppler shift range.

The communication and processing circuitry 1142 may further be configured to obtain a random access preamble message based on the cyclic shift configuration. The communication and processing circuitry 1142 may further be configured to execute communication and processing instructions (software) 1152 stored in the computer-readable medium 1106 to implement one or more of the functions described herein.

The processor 1104 may further include RACH circuitry 1144, configured to generate (configure) the cyclic shift configuration 1116. The RACH circuitry 1144 may further be configured to process the random access preamble message and perform a RACH procedure as shown, for example, in FIGS. 4 and/or 8. The RACH circuitry 1144 may further be configured to execute RACH instructions (software) 1154 stored in the computer-readable medium 1106 to implement one or more of the functions described herein.

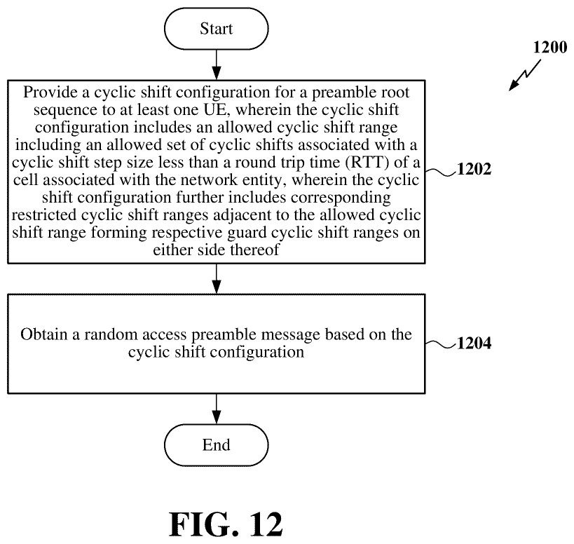

FIG. 12 is a flow chart of an exemplary process 1200 for configuring an over-provisioned cyclic shift configuration for a random access procedure according to some aspects. As described below, some or all illustrated features may be omitted in a particular implementation within the scope of the present disclosure, and some illustrated features may not be required for implementation of all examples. In some examples, the method may be performed by the network entity 1100, as described above and illustrated in FIG. 11, by a processor or processing system, or by any suitable means for carrying out the described functions.

At block 1202, the network entity may provide a cyclic shift configuration for a preamble root sequence to at least one user equipment (UE). The cyclic shift configuration can include an allowed cyclic shift range including an allowed set of cyclic shifts associated with a cyclic shift step size less than a maximum round trip time (RTT) of a cell associated with the network entity. The cyclic shift configuration can further include corresponding restricted cyclic shift ranges adjacent to the allowed cyclic shift range on either side thereof. For example, the communication and processing circuitry 1142 together with the communication interface 1110, shown and described above in connection with FIG. 11, may provide a means to provide the cyclic shift configuration.

In some examples, the allowed set of cyclic shifts include a first set of cyclic shifts having a first cyclic shift step size equal to or greater than the maximum RTT and a second set of cyclic shifts within a cyclic shift region that includes respective cyclic shift durations of the first set of cyclic shifts excluding a last cyclic shift of the first set of cyclic shifts. In some examples, the second set of cyclic shifts includes a second cyclic shift step size offset from the first cyclic shift step size, where the offset is less than the maximum RTT. In some examples, the second cyclic shift step size within each of the respective cyclic shift durations is less than the maximum RTT. In some examples, the allowed set of cyclic shifts includes a respective range of cyclic shifts within the respective cyclic shift durations of the first set of cyclic shifts excluding the last cyclic shift of the first set of cyclic shifts. In some examples, the respective range of cyclic shifts includes all cyclic shifts within the respective cyclic shift durations of the first set of cyclic shifts excluding the last cyclic shift of the first set of cyclic shifts. In some examples, the allowed set of cyclic shifts includes individual cyclic shifts within the respective cyclic shift durations of the first set of cyclic shifts excluding the last cyclic shift of the first set of cyclic shifts, where the cyclic shift step size between the individual cyclic shifts is a fraction of the maximum RTT.

In some examples, the cyclic shift configuration includes at least two cyclic shift groups, where each of the cyclic shift groups includes a respective allowed cyclic shift range and respective corresponding restricted cyclic shift ranges for the corresponding cyclic shift group. In some examples, the communication and processing circuitry 1142 is configured to receive a respective cyclic shift configuration for each preamble root sequence of a plurality of preamble root sequences, each including a respective allowed cyclic shift range with a respective cyclic shift step size less than the maximum RTT and respective corresponding restricted cyclic shift ranges adjacent to the allowed cyclic shift range on either side thereof. In some examples, each of the restricted cyclic shift ranges corresponds to a first Doppler shift range or a second Doppler shift range greater than the first Doppler shift range.

At block 1204, the network entity may obtain a random access preamble message based on the cyclic shift configuration. For example, the communication and processing circuitry 1142 together with the communication interface 1110, shown and described above in connection with FIG. 11, may provide a means to obtain the random access preamble message.

In one configuration, the network entity 1100 includes means for providing a cyclic shift configuration for a preamble root sequence to at least one user equipment (UE), wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof, and means for obtaining a random access preamble message based on the cyclic shift configuration, as described in the present disclosure. In one aspect, the aforementioned means may be the processor 1104 shown in FIG. 11 configured to perform the functions recited by the aforementioned means. In another aspect, the aforementioned means may be a circuit or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1 and/or 2 utilizing, for example, the processes and/or algorithms described herein in relation to FIGS. 4, 8, and/or 12.

The processes shown in FIGS. 10 and 12 may include additional aspects, such as any single aspect or any combination of aspects described below and/or in connection with one or more other processes described elsewhere herein.

Aspect 1: A method operable at a network entity, the method comprising: providing a cyclic shift configuration for a preamble root sequence to at least one user equipment (UE), wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and obtaining a random access preamble message based on the cyclic shift configuration.

Aspect 2: The method of aspect 1, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

Aspect 3: The method of aspect 2, wherein the second set of cyclic shifts comprises a second cyclic shift step size offset from the first cyclic shift step size, wherein the offset is less than the maximum RTT.

Aspect 4: The method of aspect 3, wherein the second cyclic shift step size within each of the respective cyclic shift durations is less than the maximum RTT.

Aspect 5: The method of any of aspects 2 through 4, wherein the allowed set of cyclic shifts comprises a respective range of cyclic shifts within the respective cyclic shift durations of the first set of cyclic shifts excluding the last cyclic shift of the first set of cyclic shifts.

Aspect 6: The method of aspect 5, wherein the respective range of cyclic shifts comprises all cyclic shifts within the respective cyclic shift durations of the first set of cyclic shifts excluding the last cyclic shift of the first set of cyclic shifts.

Aspect 7: The method of any of aspects 2 through 4, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.

Aspect 8: The method of any of aspects 2 through 7, wherein the cyclic shift configuration comprises at least two cyclic shift groups, wherein each of the cyclic shift groups comprises a respective allowed cyclic shift range and respective corresponding restricted cyclic shift ranges for the corresponding cyclic shift group.

Aspect 9: The method of any of aspects 1 through 8, further comprising: providing a respective cyclic shift configuration for each preamble root sequence of a plurality of preamble root sequences including the preamble root sequence, wherein each of the respective cyclic shift configurations comprises a respective allowed cyclic shift range with a respective cyclic shift step size less than the maximum RTT and respective corresponding restricted cyclic shift ranges adjacent to the allowed cyclic shift range on either side thereof.

Aspect 10: The method of any of aspects 1 through 9, wherein each of the restricted cyclic shift ranges corresponds to a first Doppler shift range or a second Doppler shift range greater than the first Doppler shift range.

Aspect 11: An apparatus at a network entity comprising one or more memories and one or more processors coupled to the one or more memories, wherein the one or more processors are configured to perform a method of any of aspects 1 through 10.

Aspect 12: An apparatus at a network entity comprising means for performing a method of any of aspects 1 through 10.

Aspect 13: A non-transitory computer-readable medium having stored therein instructions executable by one or more processors of a network entity to perform a method of any of aspects 1 through 10.

Aspect 14: A method operable at a user equipment (UE), the method comprising: receiving a cyclic shift configuration for a preamble root sequence from a network entity, wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and transmitting a random access preamble message based on the cyclic shift configuration.

Aspect 15: The method of aspect 14, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

Aspect 16: The method of aspect 15, wherein the second set of cyclic shifts comprises a second cyclic shift step size offset from the first cyclic shift step size, wherein the offset is less than the maximum RTT.

Aspect 17: The method of aspect 16, wherein the second cyclic shift step size within each of the respective cyclic shift durations is less than the maximum RTT.

Aspect 18: The method of any of aspects 15 through 17, wherein the allowed set of cyclic shifts comprises a respective range of cyclic shifts within the respective cyclic shift durations of the first set of cyclic shifts excluding the last cyclic shift of the first set of cyclic shifts.

Aspect 19: The method of aspect 18, wherein the respective range of cyclic shifts comprises all cyclic shifts within the respective cyclic shift durations of the first set of cyclic shifts excluding the last cyclic shift of the first set of cyclic shifts.

Aspect 20: The method of any of aspects 15 through 17, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.

Aspect 21: The method of any of aspects 15 through 20, wherein the cyclic shift configuration comprises at least two cyclic shift groups, wherein each of the cyclic shift groups comprises a respective allowed cyclic shift range and respective corresponding restricted cyclic shift ranges for the corresponding cyclic shift group.

Aspect 22: The method of any of aspects 14 through 21, further comprising: receiving a respective cyclic shift configuration for each preamble root sequence of a plurality of preamble root sequences including the preamble root sequence, wherein each of the respective cyclic shift configurations comprises a respective allowed cyclic shift range with a respective cyclic shift step size less than the maximum RTT and respective corresponding restricted cyclic shift ranges adjacent to the allowed cyclic shift range on either side thereof.

Aspect 23: The method of any of aspects 14 through 22, wherein each of the restricted cyclic shift ranges corresponds to a first Doppler shift range or a second Doppler shift range greater than the first Doppler shift range.

Aspect 24: The method of any of aspects 14 through 23, further comprising: selecting an allowed cyclic shift from the allowed set of cyclic shifts; and transmitting the random access preamble message using the allowed cyclic shift.

Aspect 25: The method of aspect 21, wherein the restricted cyclic shift ranges comprise prohibited cyclic shifts prohibited from being selected for the random access preamble message.

Aspect 26: An apparatus at a user equipment (UE) comprising one or more memories and one or more processors coupled to the one or more memories, wherein the one or more processors are configured to perform a method of any of aspects 14 through 25.

Aspect 27: An apparatus at a UE comprising means for performing a method of any of aspects 14 through 25.

Aspect 28: A non-transitory computer-readable medium having stored therein instructions executable by one or more processors of a UE to perform a method of any of aspects 14 through 25.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 8, 9 and/or 11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus at a network entity, comprising:
one or more memories; and
one or more processors coupled to the one or more memories, wherein the one or more processors are configured to:
provide a cyclic shift configuration for a preamble root sequence to at least one user equipment (UE), wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and
obtain a random access preamble message based on the cyclic shift configuration.

2. The apparatus of claim 1, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

3. The apparatus of claim 2, wherein the second set of cyclic shifts comprises a second cyclic shift step size offset from the first cyclic shift step size, wherein the offset is less than the maximum RTT.

4. The apparatus of claim 3, wherein the second cyclic shift step size within each of the respective cyclic shift durations is less than the maximum RTT.

5. The apparatus of claim 2, wherein the allowed set of cyclic shifts comprises a respective range of cyclic shifts within the respective cyclic shift durations of the first set of cyclic shifts excluding the last cyclic shift of the first set of cyclic shifts.

6. The apparatus of claim 5, wherein the respective range of cyclic shifts comprises all cyclic shifts within the respective cyclic shift durations of the first set of cyclic shifts excluding the last cyclic shift of the first set of cyclic shifts.

7. The apparatus of claim 2, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.

8. The apparatus of claim 1, wherein the cyclic shift configuration comprises at least two cyclic shift groups, wherein each of the cyclic shift groups comprises a respective allowed cyclic shift range and respective corresponding restricted cyclic shift ranges for the corresponding cyclic shift group.

9. The apparatus of claim 1, wherein the one or more processors are further configured to:
provide a respective cyclic shift configuration for each preamble root sequence of a plurality of preamble root sequences including the preamble root sequence, wherein each of the respective cyclic shift configurations comprises a respective allowed cyclic shift range with a respective cyclic shift step size less than the maximum RTT and respective corresponding restricted cyclic shift ranges adjacent to the allowed cyclic shift range on either side thereof.

10. The apparatus of claim 1, wherein each of the restricted cyclic shift ranges corresponds to a first Doppler shift range or a second Doppler shift range greater than the first Doppler shift range.

11. A method operable at a network entity, the method comprising:
providing a cyclic shift configuration for a preamble root sequence to at least one user equipment (UE), wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and
obtaining a random access preamble message based on the cyclic shift configuration.

12. The method of claim 11, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

13. The method of claim 12, wherein the allowed set of cyclic shifts comprises a respective range of cyclic shifts within the respective cyclic shift durations of the first set of cyclic shifts excluding the last cyclic shift of the first set of cyclic shifts.

14. The method of claim 12, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.

15. An apparatus at a user equipment (UE), comprising:
one or more memories; and
one or more processors coupled to the one or more memories, wherein the one or more processors are configured to:
receive a cyclic shift configuration for a preamble root sequence from a network entity, wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and
transmit a random access preamble message based on the cyclic shift configuration.

16. The apparatus of claim 15, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

17. The apparatus of claim 16, wherein the second set of cyclic shifts comprises a second cyclic shift step size offset from the first cyclic shift step size, wherein the offset is less than the maximum RTT.

18. The apparatus of claim 17, wherein the second cyclic shift step size within each of the respective cyclic shift durations is less than the maximum RTT.

19. The apparatus of claim 16, wherein the allowed set of cyclic shifts comprises a respective range of cyclic shifts within the respective cyclic shift durations of the first set of cyclic shifts excluding the last cyclic shift of the first set of cyclic shifts.

20. The apparatus of claim 19, wherein the respective range of cyclic shifts comprises all cyclic shifts within the respective cyclic shift durations of the first set of cyclic shifts excluding the last cyclic shift of the first set of cyclic shifts.

21. The apparatus of claim 16, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.

22. The apparatus of claim 16, wherein the cyclic shift configuration comprises at least two cyclic shift groups, wherein each of the cyclic shift groups comprises a respective allowed cyclic shift range and respective corresponding restricted cyclic shift ranges for the corresponding cyclic shift group.

23. The apparatus of claim 15, wherein the one or more processors are further configured to:
receive a respective cyclic shift configuration for each preamble root sequence of a plurality of preamble root sequences including the preamble root sequence, wherein each of the respective cyclic shift configurations comprises a respective allowed cyclic shift range with a respective cyclic shift step size less than the maximum RTT and respective corresponding restricted cyclic shift ranges adjacent to the allowed cyclic shift range on either side thereof.

24. The apparatus of claim 15, wherein each of the restricted cyclic shift ranges corresponds to a first Doppler shift range or a second Doppler shift range greater than the first Doppler shift range.

25. The apparatus of claim 15, wherein the one or more processors are further configured to:
select an allowed cyclic shift from the allowed set of cyclic shifts; and
transmit the random access preamble message using the allowed cyclic shift.

26. The apparatus of claim 25, wherein the restricted cyclic shift ranges comprise prohibited cyclic shifts prohibited from being selected for the random access preamble message.

27. A method operable at a user equipment (UE), the method comprising:
receiving a cyclic shift configuration for a preamble root sequence from a network entity, wherein the cyclic shift configuration comprises an allowed cyclic shift range comprising an allowed set of cyclic shifts associated with a cyclic shift step size less than a maximum round trip time (RTT) of a cell associated with the network entity, wherein the cyclic shift configuration further comprises corresponding restricted cyclic shift ranges adjacent to the allowed cyclic shift range on either side thereof; and
transmitting a random access preamble message based on the cyclic shift configuration.

28. The method of claim 27, wherein the allowed set of cyclic shifts comprise a first set of cyclic shifts comprising a first cyclic shift step size equal to or greater than the maximum RTT and a second set of cyclic shifts within a cyclic shift region that comprises respective cyclic shift durations of the first set of cyclic shifts excluding a last cyclic shift of the first set of cyclic shifts.

29. The method of claim 28, wherein the allowed set of cyclic shifts comprises a respective range of cyclic shifts within the respective cyclic shift durations of the first set of cyclic shifts excluding the last cyclic shift of the first set of cyclic shifts.

30. The method of claim 28, wherein the allowed set of cyclic shifts comprises individual cyclic shifts within the respective cyclic shift durations of the first set of cyclic shifts excluding the last cyclic shift of the first set of cyclic shifts, wherein the cyclic shift step size between the individual cyclic shifts is a fraction of the maximum RTT.
